(19) United States
(12) Patent Application Publication
(10) Pub. No.: US 2006/0105233 A1
(43) Pub. Date: May 18, 2006

(54) Battery

(76) Inventor: Hiroyuki Morita, Fukushima (JP)

Correspondence Address: William E. Vaughan;Bell, Boyd & Lloyd LLC, P.O. Box 1135, Chicago, IL, 60690, US

(21) Appl. No.: 11/274,787

(22) Filed: Nov. 15, 2005

(30) Foreign Application Priority Data
Nov. 18, 2004 (JP) P2004-334794
Nov. 18, 2004 (JP) P2004-334795
Feb. 7, 2005 (JP) P2005-030096

(51) Int. Cl. H01M 6/12; H01M 4/40; H01M 4/66

(52) U.S. Cl. 429/162; 429/245; 429/231.95

(57) ABSTRACT

A battery is provided. The battery includes positive electrode in which a positive electrode active substance layer is formed on a positive electrode collector made of a strip-shaped metal foil; a negative electrode made of metal lithium or a metal lithium alloy; and a separator. In the positive electrode, the positive electrode active substance layer is formed only on one surface of the positive electrode collector and the positive electrode is bent so that the positive electrode active substance layers face each other. The negative electrode is arranged in a portion where the positive electrode active substance layers face each other.

### CROSS REFERENCES TO RELATED APPLICATIONS

The present application claims priority to Japanese Patent Application No. 2004-334794 filed on Nov. 18, 2004, Japanese Patent Application No. 2004-334795 filed on Nov. 18, 2004 and Japanese Patent Application No. 2005-030096 filed on Feb. 7, 2005, the entire contents of which being incorporated herein by reference.

### BACKGROUND

The invention relates to a flat type primary battery having excellent battery characteristics and productivity.

At present, coin type lithium batteries are used as a power source for clocks and a power source for a memory backup of electronics products such as personal computer, copying apparatus, video camera, gaming machine, and the like. Further, an application to a driving power source in a wide use temperature range from a high temperature to a low temperature in a vending machine, a gas meter, a smart key system, a tire pressure monitoring system, an on-vehicle navigation system, an electronic shelf label system, and the like is expected.

However, in recent years, a large number of applications in which a plurality of coin type batteries are connected in parallel and used in order to satisfy load characteristics and a discharge capacitance which are necessary on the apparatus side using the coin type battery and a shape (thin type) which is demanded for the battery have been proposed. Such using methods have been made because the load characteristics and the discharge capacitance of the coin type battery in which a reactive area of an electrode is very small do not satisfy needs of the applications.

Ordinarily, since welding or the like is necessary to arrange a battery into an apparatus, its manufacturing steps become very complicated and there is a very large restriction upon designing of the apparatus. In addition, if the number of batteries which are connected in parallel increases to three or more, a problem is caused by a variation in capacitance among the batteries. For example, there is a fear that the battery whose discharge capacitance is smaller than those of the other batteries continues to discharge even in the state where the discharge is finished in the ordinary case and causes an over discharge, or such a battery is charged from another battery and generation of gases an internal short-circuit is caused, so that it is very dangerous.

To solve such a problem, a rectangular battery which can improve the battery capacitance by effectively using a space in the battery is used.

As shown in JP-A-6-187998, therefore, by folding electrodes into a folding screen shape and forming a battery, the battery in which a reactive area is increased, a large current can be supplied, and a thin size can be realized can be obtained.

FIG. 1 is a schematic diagram showing a construction of a battery according to an embodiment in JP-A-6-187998. According to the invention of JP-A-6-187998, a protective sheet 4 is provided for each of a positive electrode formed by coating the surface of a substrate 3 having insulation performance or the surface of a positive electrode collector 1b provided for the substrate 3 having the insulation performance with a positive electrode active substance 1a and a negative electrode formed by coating the surface of the substrate 3 having the insulation performance or the surface of a negative electrode collector 2b provided for the substrate 3 having the insulation performance with a negative electrode active substance 2a and they are folded in the state as shown in FIG. 1, thereby forming a battery device. The battery device is enclosed into an exterior can made of a metal material or a battery casing made of a resin material, thereby forming the battery.

In a battery in which metal lithium or a metal lithium alloy is used for a negative electrode, as the discharge progresses, lithium is consumed and the negative electrode becomes lean. However, in the case of the coin type lithium battery or the battery using the metal casing as an exterior as disclosed in JP-A-6-187998 mentioned above, the metal casing is difficult to trace a change in dimensions of the battery device due to the consumption of lithium and a contact state between the positive and negative electrodes or a contact state between the positive electrode and a positive electrode casing deteriorates. Therefore, particularly, at the end of the discharge, such a problem that an impedance in the battery rises and the load characteristics deteriorate extremely occurs.

### SUMMARY

It is, therefore, desirable to solve the above problems and to provide a battery having load characteristics even at the end of the discharge and excellent productivity although it is a thin type.

To solve the above problems, according to an embodiment of the invention, there is provided a battery wherein a positive electrode in which a positive electrode active substance layer is formed only on one side of a positive electrode collector made of a metal foil is bent so that the positive electrode active substance layers face each other, and a negative electrode made of metal lithium or a metal lithium alloy is arranged, through a separator, between the surfaces where the positive electrode active substance layers face each other. In this instance, an active substance layer non-coating portion can be also provided for the bending portion where the positive electrode is bent.

According to an embodiment of the invention, there is provided a battery wherein a positive electrode in which a positive electrode active substance layer is formed only on one side of a positive electrode collector made of a metal foil is bent so that the positive electrode active substance layers face each other, and a negative electrode formed by pressure-bonding metal lithium or a metal lithium alloy onto a negative electrode collector is arranged, through a separator, between the surfaces where the positive electrode active substance layers face each other.

Preferably, the battery has an opening in a part or all of the lithium pressure-bonding surface of the collector which is used for the negative electrode.

According to an embodiment of the invention, there is provided a battery wherein a positive electrode in which a positive electrode active substance layer is formed only on one side of a positive electrode collector made of a metal foil is bent so that the positive electrode active substance layers face each other, a positive electrode active substance layer non-coating portion is provided for a positive electrode end portion, and a positive electrode terminal is melt-bonded to the non-coating portion or a back surface of the non-coating portion. One end portion of the positive electrode can be also come into contact with another positive electrode end portion so as to cover a negative electrode.

According to an embodiment of the invention, by effectively arranging the electrodes, a large electrode area can be obtained, an internal resistance of the battery is reduced, and the battery having high battery characteristics can be formed. Since one surface of the metal foil is merely coated with the active substance, the excellent productivity is obtained and costs necessary for the investment in plant and equipment can be also reduced.

According to an embodiment of the invention, since conduction can be assured by the negative electrode collector even at the end of the discharge, the sudden deterioration of the load characteristics and the shortage of the capacitance can be prevented.

Further, according to an embodiment of the invention, by forming the non-coating portion of the active substance to the end portion on the collector and arranging the electrode terminal to the back surface of the non-coating portion, the dropout of the active substance which is caused upon welding of the electrode terminal is prevented, the productivity is improved, and the high battery capacitance can be maintained. By overlapping the active substance non-coating portion of the collector end portion to another end portion and allowing the collectors to be come into electrical contact with each other, the internal resistance of the battery is reduced and the battery characteristics can be improved.

Additional features and advantages are described herein, and will be apparent from, the following Detailed Description and the figures.

### BRIEF DESCRIPTION OF THE FIGURES

FIG. 1 is a cross sectional view for explaining a battery construction of JP-A-6-1 87998.

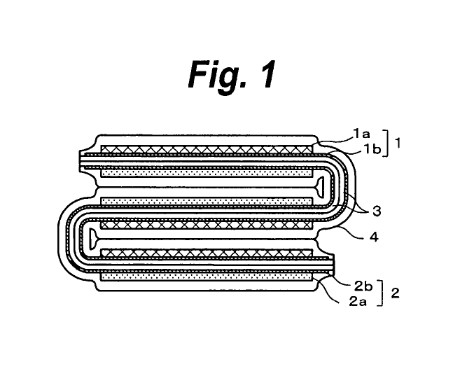

FIG. 2 is a schematic diagram showing an external view of a battery formed by applying the first embodiment.

FIG. 3 is a cross sectional view in the case where electrodes are bent and a battery device is formed.

FIG. 4 is a schematic diagram showing the state where the electrodes are bent.

FIG. 5 is a cross sectional view showing a construction of a laminated film which is used as an exterior when the battery is formed by applying the first embodiment.

FIG. 6 is a schematic diagram showing the state where the battery device is externally packaged with the laminated film.

FIG. 7 is a cross sectional view in the case where the battery device is formed by providing active substance non-coating portions for a bending portion.

FIGS. 8A to 8D are schematic diagrams showing the state where a crack occurs in an active substance layer in the case where a collector is bent in mountain-folding manner.

FIG. 9 is a schematic diagram showing the state of the bending portion in the case where the collector is bent in mountain-folding manner.

FIG. 10 is a schematic diagram showing a part of the bending portion in the case there the collector is bent in mountain-folding manner.

FIG. 11 is a schematic diagram showing the state of the mountain-folding bending portion in the case there a proper non-coating portion is provided.

FIG. 12 is a cross sectional view showing the state where a positive electrode width of an outermost surface is set to be larger than that of an inner surface.

FIG. 13 is a schematic diagram showing a battery construction in the case where the end portions of the laminated electrodes are adhered with a tape, thereby preventing projection of the negative electrode.

FIG. 14 is a graph showing results obtained in the case where a closed circuit voltage (CCV) during discharge of 10 mA under an environment of −40° C. is measured every depth of battery discharge (DOD).

FIGS. 15A to 15D are schematic diagrams showing screen printing steps.

FIG. 16 is a cross sectional view showing a construction of a lithium battery using a positive electrode for which the active substance non-coating portions are provided by the screen printing.

FIG. 17 is a cross sectional view showing the state in the middle of the discharge of the lithium battery using the positive electrode for which the active substance non-coating portions are provided by the screen printing.

FIG. 18 is a cross sectional view showing the state at the end of the discharge of the lithium battery using the positive electrode for which the active substance non-coating portions are provided by the screen printing.

FIG. 19 is a schematic diagram showing a negative electrode collector to which the second embodiment is applied.

FIG. 20 is a schematic diagram showing the negative electrode collector to which the second embodiment is applied.

FIG. 21 is a cross sectional view showing a lithium battery to which the second embodiment is applied.

FIG. 22 is a cross sectional view showing the state at the end of the discharge of the lithium battery to which the second embodiment is applied.

FIG. 23 is a schematic diagram showing a negative electrode used in Example 3-1.

FIG. 24 is a schematic diagram showing a negative electrode used in Comparison 3-1.

FIG. 25 is a graph showing measurement results in the embodiment 3.

FIG. 26 is a schematic diagram showing a structure of a positive electrode of the first and second embodiments.

FIG. 27 is a cross sectional view of a battery formed by applying the third embodiment.

FIG. 28 is a schematic diagram showing a positive electrode to which the third embodiment is applied.

FIG. 29 is a schematic diagram showing a construction of the battery to which the third embodiment is applied.

FIG. 30 is a schematic diagram showing a battery device formed by applying the third embodiment.

FIG. 31 is a schematic diagram showing a manufacturing method of the battery to which the third embodiment is applied.

FIG. 32 is a schematic diagram showing an external view of the battery to which the third embodiment is applied; and

FIG. 33 is a cross sectional view showing a construction of a battery formed in Comparison 5-1.

### DETAILED DESCRIPTION

An embodiment of the invention will now be described hereinbelow with reference to the drawings.

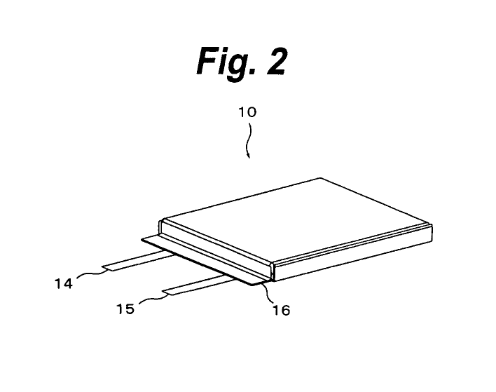

FIG. 2 shows a construction of a battery 10 to which the invention is applied. An exterior of the battery 10 is made of a laminated film 16 and a positive electrode terminal 14 connected to a positive electrode and a negative electrode terminal 15 connected to a negative electrode are led out of an adhering portion of the laminated film 16, thereby forming the battery 10.

A manufacturing method of the battery to which the invention is applied will be described hereinbelow.

[Positive Electrode]

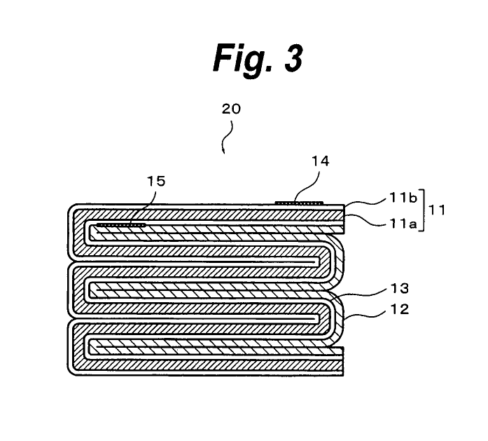

Referring now to FIG. 3, a positive electrode 11 is formed by forming a positive electrode active substance layer 11a containing a positive electrode active substance onto one surface of a positive electrode collector 11b. The positive electrode collector 11b is made of, for example, a metal foil such as aluminum (Al) foil, nickel (Ni) foil, titanium (Ti) foil, stainless steel (SUS) foil, or the like.

The positive electrode active substance layer 11a is made by containing, for example, the positive electrode active substance, a conductive material, and a binding agent. A positive mix is formed by uniformly mixing them. The positive mix is dispersed into a solvent, thereby obtaining a slurry-like solvent. At this time, adjustment is made by using a thickener so as to have predetermined viscosity. Subsequently, the surface of the positive electrode collector 11b is uniformly coated with such a slurry and the collector 11b is dried by a vacuum dryer in order to remove the moisture in the positive mix, thereby forming the positive electrode 11. It is sufficient here that the positive electrode active substance, conductive material, binding agent, and solvent are uniformly dispersed and their mixture ratio is not limited.

As a positive electrode active substance, manganese dioxide or graphite fluoride can be selected in the case of the battery of the 3V system or iron sulfide can be selected in the case of the battery of the 1.5V system. Each mass energy density is equal to 308 mAh/g for manganese dioxide, 860 mAh/g for graphite fluoride, 890 mAh/g for second iron sulfide, and 3860 mAh/g for lithium metal which is used as a counter electrode.

As a conductive material, for example, a carbon material such as carbon black, graphite, acetylene black, or the like is used. As a binding agent, for example, polyvinylidene fluoride, styrene butadiene rubber (SBR), or the like is used. As a solvent, for example, ethanol or the like is used.

The positive electrode active substance layer 11a can be formed by using a diecoating method, a transfer printing method, a screen printing method, or the like. When considering a viewpoint of the productivity and equipment costs, it is desirable to coat only one surface of the metal foil with the active substance. That is, in the case where both surfaces are coated with the active substance, in order to execute manufacturing steps by using one machine, a step of drying the electrode printed on one surface and, thereafter, winding the electrode and a step of coating the back surface with the active substance again, drying the electrode, and winding it are necessary, or in the case of coating by the continuous steps for the front and back surfaces in which just after one surface is coated with the active substance and the active substance is dried, the back surface is coated with the active substance, and the electrode is dried and wound, as equipment for coating the active substance, two equipment constructed by one for the front surface and one for the back surface are necessary and the costs extremely rise. To solve such a problem, by constructing the electrodes by the simplex (one-side) printing, the productivity can be improved and the costs necessary for the investment in plant and equipment can be remarkably reduced.

In the positive electrode 11 produced by forming the positive electrode active substance layer 11a onto the positive electrode collector 11b, a positive electrode terminal 14 is connected to a positive electrode end portion by spot welding, ultrasonic welding, or the like. Although it is desirable to use a metal foil as a positive electrode terminal 14, it is not limited to the metal but another material can be used so long as it is electrochemically and chemically stable and the conduction can be made. For example, aluminum or the like can be mentioned as a material of the positive electrode terminal.

[Negative Electrode]

As a negative electrode 12, metal lithium or a metal lithium alloy (in the case where it is not particularly limited to metal lithium or the metal lithium alloy, it is properly referred to as “lithium”) is used. In a manner similar to the positive electrode 11, in the negative electrode 12, a negative electrode terminal 15 is also connected to an end portion by spot welding, ultrasonic welding, or the like. Although it is desirable to use a metal foil as a negative electrode terminal 15, it is not limited to the metal but another material can be used so long as it is electrochemically and chemically stable and the conduction can be made. For example, copper (Cu), nickel, stainless steel, stainless steel or iron (Fe) coated with nickel, or the like can be mentioned as a material of the negative electrode terminal.

[Separator]

A separator 13 is selected from a microporous film or an unwoven cloth selected from one or a plurality of kinds among resin materials whose raw materials are glass fiber, ceramics fiber, polyphenylene sulfide, polyvinylidene fluoride, poly tetrafluoro ethylene, polybuthylene terephthalate, polypropylene, polyethylene, and the like. Among them, when an attention is paid to the improvement of low-temperature characteristics, the microporous film is desirable because a width between the positive and negative electrodes can be narrowed.

[Electrolytic Solution]

As an organic solvent of an electrolytic solution, it is possible to select an arbitrary one or a plurality of kinds among polycarbonate, ethylene carbonate, butylene carbonate, γ-butyrolactone, sulfolane, 3-methyl sulfolane, dimethoxy ethane, dimethyl carbonate, ethyl methyl carbonate, and diethyl carbonate, 1,3 dioxolane.

As an electrolytic salt, it is possible to select an arbitrary one or a plurality of kinds among lithium perchlorate, hexafluoride lithium phosphate, trifluoride methane lithium sulfonate, tetrafluoride lithium boric acid, lithium iodide, and the like.

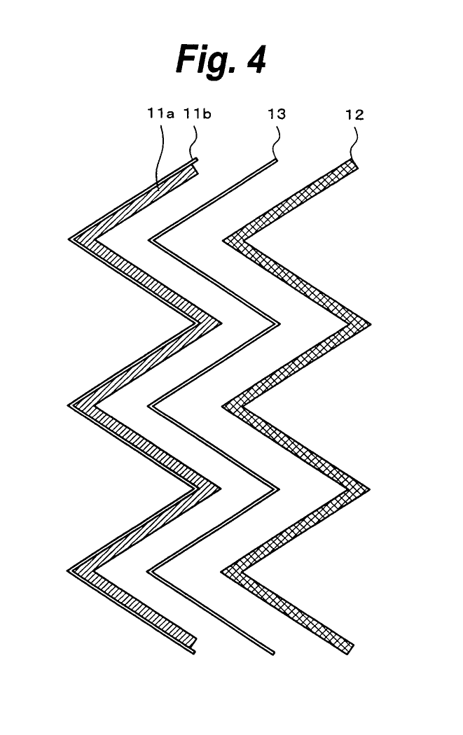

A battery device 20 is formed by using such materials as mentioned above. As shown in FIGS. 3 and 4, the positive electrode 11 is bent three or more times so that the surfaces of the positive electrode active substance layer 11a formed on one surface of the positive electrode collector 11b face each other. The negative electrode 12 made of lithium is arranged, through the separator 13, between the surfaces where the positive electrode active substance layers 11a face. By allowing the surfaces of the positive electrode active substance layer 11a to face inwardly, the negative electrode 12 is not exposed to the outside other than the edge surface. As for lithium, since the activity is very high and the moisture can be easily absorbed, it is handled in an environment of a low dew point such as a dry room or the like. However, even in such an environment, the moisture generated from the worker or the like is absorbed, a film of lithium hydroxide or the like is formed, and the characteristics of the battery are deteriorated. Therefore, it is very important to rapidly assemble the electrode device by the positive electrode through the separator and cover its surface in the manufacturing steps in the case of handling the negative electrode.

[Manufacturing of Battery]

The battery device 20 manufactured as mentioned above is covered with an exterior material made of the laminated film 16 having a thickness of about 100 μm, thereby forming the battery 10. The following materials can be used for the construction of the laminated film 16 which is used for forming the battery 10.

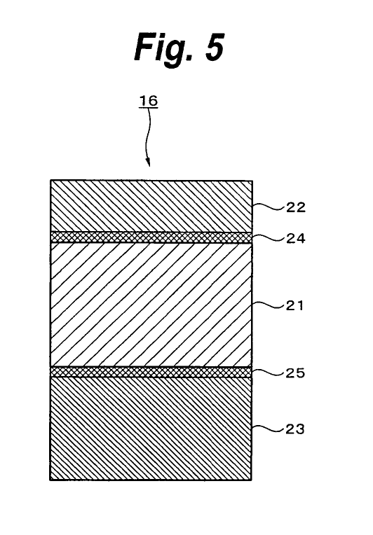

FIG. 5 shows an example of a main construction of the laminated film 16. A metal layer 21 is made of a multilayer film having moisture proof and insulation performance sandwiched between an exterior layer 22 made of a resin film and an interior layer 23 (hereinbelow, also properly referred to as a sealant layer) made of a resin film. The metal layer 21 has an important role for improving a strength of the exterior material and protecting the contents by obstructing the intrusion of the moisture, oxygen, and light. Stainless steel, nickel-plated iron, or the like can be properly used as a material of the metal layer 21. Aluminum (Al) is most preferable in consideration of lightness, extensibility, price, and ease of working. If necessary, an adhesive layer 25 can be also provided between the metal layer 21 and the sealant layer 23 and an adhesive layer 24 can be also provided between the metal layer 21 and the exterior layer 22, respectively.

Nylon (Ny), polyethylene terephthalate (PET), or polyethylene (PE) is used for the exterior layer 22 in consideration of beauty of an external appearance, strength, flexibility, and the like. Therefore, a plurality of kinds can be also selected from them and used.

The sealant layer 23 is a portion which is fused by heat or an ultrasonic wave and mutually melt-bonded. Besides polyethylene (PE), non-drawing polypropylene (CPP), polyethylene terephthalate (PET), and nylon (Ny), low-density polyethylene (LDPE), high-density polyethylene (HDPE), or straight chain low-density polyethylene (LLDPE) can be used for the sealant layer 23. Therefore, a plurality of kinds can be also selected from them and used.

A most general construction of the laminated film is (exterior layer/metal foil/sealant layer)=(PET/Al/PE). The invention is not limited to such a combination but an arbitrary one of the following other general constructions of the laminated film can be also used. That is, (exterior layer/metal film/sealant layer)=Ny/Al/CPP, PET/Al/CPP, PET/Al/PET/CPP, PET/Ny/Al/CPP, PET/Ny/Al/Ny/CPP, PET/Ny/Al/Ny/PE, Ny/PE/Al/LLDPE, PET/PE/Al/PET/LDPE, or PET/Ny/Al/LDPE/CPP. As mentioned above, naturally, a metal other than Al can be also used as a metal foil.

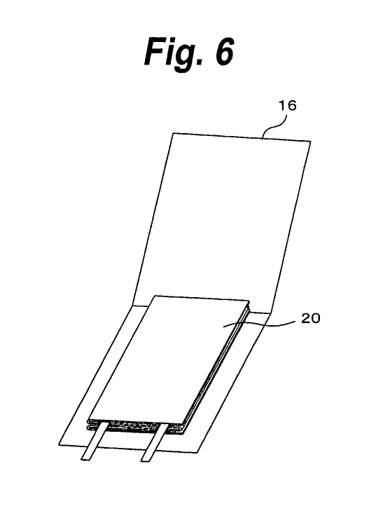

As shown in FIG. 6, the battery device 20 is sandwiched between the laminated films 16 as mentioned above and the laminated films are thermally melt-bonded while leaving one side adapted to inject an electrolytic solution. The electrolytic solution is injected into the battery and the residual side is thermally melt-bonded under the decompression in order to eliminate the air in the battery as much as possible, thereby forming the battery 10 as shown in FIG. 2.

Since the battery device 20 is thin and the thermal melt-bonding is performed under the decompression, there are no problems even if the laminated film 16 is used as it is. However, it is also possible to mold it so as to previously have a concave portion and enable the battery device 20 to be enclosed into the concave portion in order to effectively use a volume in the battery.

By using the electrode-folding structure as mentioned above, the high productivity can be maintained. Even if the discharge progresses and a consumption amount of lithium increases and the negative electrode becomes lean, the laminated exterior is deformed by a pressure difference between the inside and the outside, and a decrease in contact area between the positive and negative electrodes can be prevented. Thus, the deterioration of the battery characteristics can be eliminated and a large current can be supplied until the end of the discharge.

By using the following methods, the battery having the more excellent productivity and higher battery characteristics can be obtained.

For example, by forming the positive electrode active substance so as to be thicker than that in the related art and forming the battery, the battery capacitance can be improved. In such a case, however, when the electrode is bent, the peel-off or dropout of the active substance occurs. Therefore, for example, in the case of using the thick electrode whose thickness is equal to or larger than 100 μm, strip-shaped electrodes have to be laminated.

However, in the case of laminating the strip-shaped electrodes, complicated steps are necessary in order to control the handling of the electrodes and the positional precision of the electrodes, so that the productivity is low.

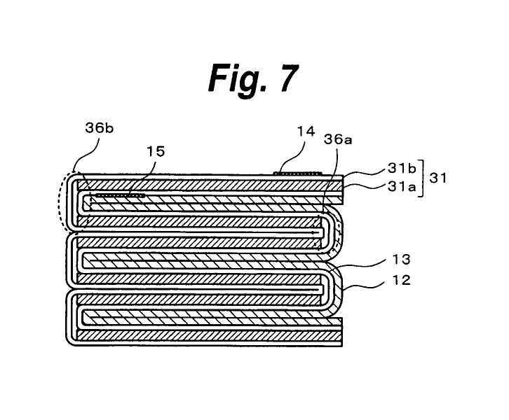

Therefore, as shown in FIG. 7, positive electrode active substance non-coating portions 36a and 36b and the like which are not coated with the positive electrode active substance are provided for the bending portions, a positive electrode 31 is bent, and the battery is formed, thereby enabling the frequency of occurrence of defects such as dropout and the like of the positive electrode active substance to be reduced. The positive electrode active substance non-coating portion 36a is a mountain-folding non-coating portion which is bent so that the positive electrode active substance layer is located to the outside. The positive electrode active substance non-coating portion 36b is a valley-folding non-coating portion which is bent so that the positive electrode active substance is located to the inside.

If the metal foil which is used as an electrode collector is printed while keeping its tension upon printing, it is more preferable for the continuous production. Therefore, a hard metal foil which is hardly extended is used. Thus, the metal foil is hardly extended in the case of bending the electrode.

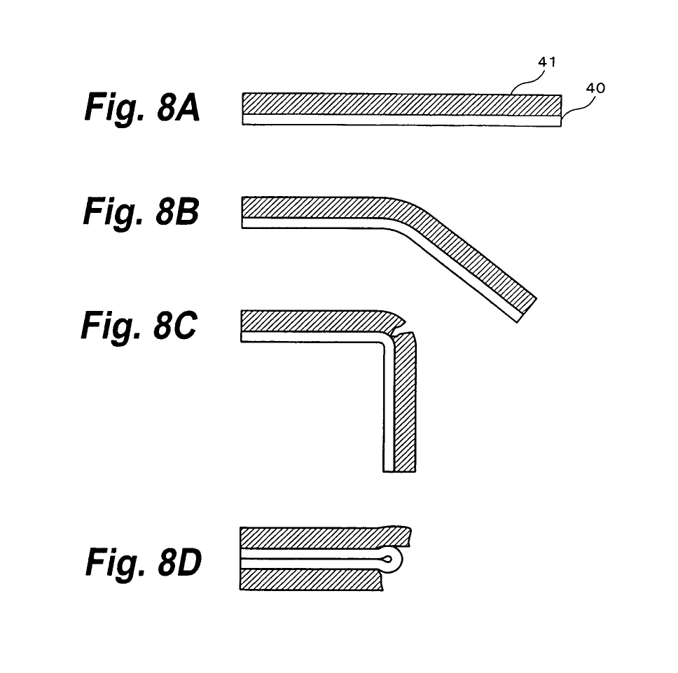

As shown in FIGS. 8A to 8D, in the case where the electrode in which an active substance layer 41 has been formed on a collector 40 is mountain-folded, extension of the portion which is come into contact with the outside of the active substance is difficult to trace the bending of the metal foil and a crack of the electrode occurs (FIG. 8C). Since the collector is spring-backed around the crack as a base point, the peel-off or dropout of the metal foil occurs. Even in the case where the non-coating portion exists, if a width of non-coating portion is insufficient, the peel-off occurs by similar reasons.

In the case where the electrode is valley-folded, since the active substance is compressed in the contracting direction, a possibility of occurrence of the dropout or peel-off is small. However, when considering the productivity, by providing the non-coating portion for this portion, the bending position of the electrode can be clarified. Thus, since the position is not deviated upon bending, it is desirable to provide the non-coating portion. At this time, it is necessary to set the width of non-coating portion to a value which is equal to or larger than 2T (T: thickness of active substance). If the electrode is coated at a width smaller than 2T, the metal foil is difficult to trace the extension of the electrode on the contrary to the case of the mountain-folding, so that the metal foil is cut.

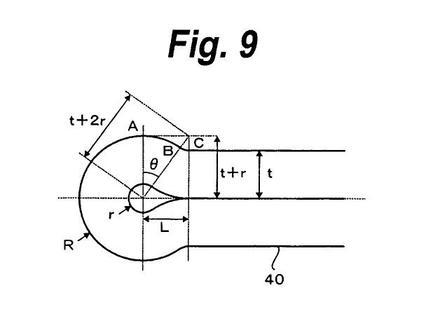

As shown in FIG. 9, when the electrode is bent, a minimum bending radius (r) also certainly occurs inside of the metal foil. R=t+r (t: thickness of metal foil, R: outside radius). An arc BC connecting an arc AB of the bent metal foil to a straight line portion of the metal foil is connected at least by the radius (r). An angle θ of the arc AB is equal to that of the arc BC. A length of line connecting the center of the arc BC and the center of the bending portion is equal to (t+2r). At this time, a relation between such a length and the outside radius R is expressed by an equation
(t+2r)cos θ=t+r

A length of arc AB is equal to A=(t+r)θ and a length of arc BC is equal to B=rθ, respectively.

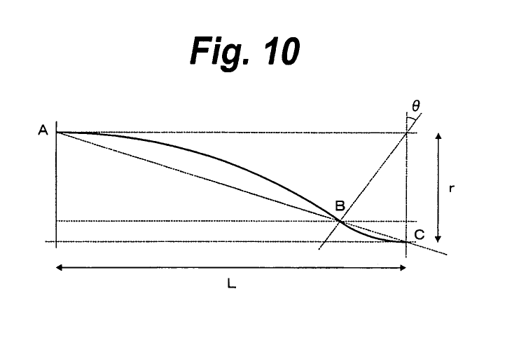

Subsequently, a length of the portion corresponding to L in FIG. 10 is equal to

$$\begin{matrix}{L}^{2} = {( t + 2 r )}^{2} - {( t + r )}^{2} \\ = 2 tr + 3 {r}^{2}\end{matrix}$$

A length (M) of straight line connecting the end portions of the arcs AB and BC can be expressed by
M²=2tr+4r²
because
M²=L²+r²

When θ is sufficiently small, M can be approximated by
M˜A+B
Therefore,
M²=(A+B)²

Thus, it can be regarded that
θ²=2r²/(t+2r)

Consequently, since a length A+B is
A+B={2(t+2r)r}^{1/2},

a width of non-coating portion necessary for the mountain-folding portion is obtained by
π(t+2r)+2×{2(t+2r)r}^{1/2}

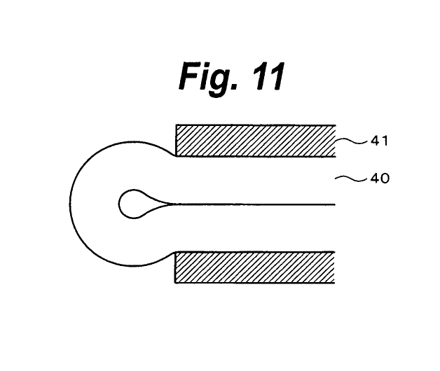

FIG. 11 shows the state of the bending portion for which the proper non-coating portion is provided. By providing the non-coating portion wider than the width as mentioned above, the bending portion where the positive electrode active substance becomes the mountain-folding portion is not coated with the active substance and there is no risk of peel-off or dropout of the active substance.

It is sufficient to provide the non-coating portion at least for the mountain-folding portion. Even in the case where the non-coating portions are provided for both of the mountain-folding portion and the valley-folding portion, there is no need to set the same width.

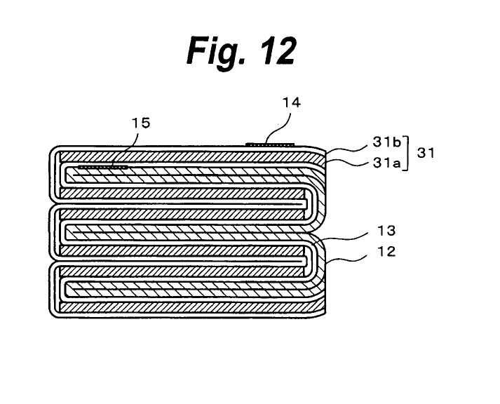

Further, as shown in FIG. 12, since a reactive area can be increased by setting the width of positive electrode locating on the outermost surface of the battery device to be larger than that of the positive electrode locating inside, it is desirable to set the positive electrode on the outermost surface to be larger than the inner positive electrode.

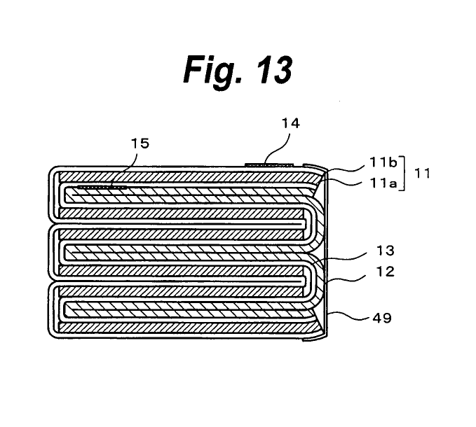

As shown in FIG. 13, it is also possible to use a structure in which the end portions of the laminated electrodes are adhered with a tape 49, thereby preventing the negative electrode 12 from being projected.

### Embodiments

Embodiments of the invention will be described in detail hereinbelow.

### Embodiment 1

Measurement of battery characteristics

[Manufacturing of Battery]

Graphite fluoride of 80.8 mass % as a positive electrode active substance and acetylene black of 15.1 mass % as a conductive material are uniformly mixed and dispersed into ethanol, thereby obtaining a slurry. After that, acetylene black as a binding agent is mixed at a ratio of 4.1 mass %. At this time, carboxymethyl cellulose dissolved into the water is mixed as a thickener and a viscosity is adjusted to a predetermined value (200 Pas), thereby obtaining a positive mix.

An aluminum foil having a thickness of 20 μm is used as a positive electrode collector. By screen printing the positive mix onto the aluminum foil, the positive electrode active substance layer is formed. The positive electrode formed as mentioned above is dried under the vacuum atmosphere and, thereafter, bent in a W-character shape as shown in FIG. 12. The microporous film is arranged as a separator and, thereafter, metal lithium is arranged as shown in FIG. 12, thereby forming the battery device. At this time, a positive electrode terminal and a negative electrode terminal are arranged onto the neighboring surfaces.

The battery device manufactured as mentioned above is sandwiched between the aluminum laminated films in which the exterior layer is made of PET, the metal layer is made of Al, and the sealant layer is made of PE, and the laminated films are thermally melt-bonded while leaving one side.

Subsequently, the electrolytic solution is injected from the opening portion of the laminated films. The electrolytic solution is made by dissolving tetrafluoride lithium boric acid of 1 mol/l into γ-butyrolactone. After the electrolytic solution is injected, the opening portion is sealed under the vacuum-degassed atmosphere, thereby forming the battery. The formed batteries are as follows.

### EXAMPLE 1-1

The battery in which a width is equal to 28 mm, a length is equal to 49 mm, a thickness is equal to 1.8 mm, and a capacitance is equal to 600 mAh is formed.

### EXAMPLE 1-2

The battery in which a width is equal to 15 mm, a length is equal to 60 mm, a thickness is equal to 2.1 mm, and a capacitance is equal to 400 mAh is formed.

The coin type batteries in the related arts are used as Comparisons. The following batteries are used as Comparisons.

Comparison 1-1

The coin type battery CR2450 in which manganese dioxide is used for the positive electrode, lithium is used for the negative electrode, and a capacitance is equal to 600 mAh is used.

Comparison 1-2

The coin type battery CR2450 in which graphite fluoride is used for the positive electrode, lithium is used for the negative electrode, and a capacitance is equal to 550 mAh is used.

Comparison 1-3

The coin type battery CR1620 in which manganese dioxide is used for the positive electrode, lithium is used for the negative electrode, and a capacitance is equal to 75 mAh is used.

The standards of the batteries of Examples and Comparisons are shown in the following Table 1.

TABLE 1

| | Capacitance | Internal | Positive electrode | Battery | Battery | Battery |
|---|---|---|---|---|---|---|
| | [mAh] | resistance [Ω] | area [cm²] | thickness [mm] | diameter [mm] | width [mm] |
| Example 1-1 | 600 | 1.2 | 4500 | 1.8 | — | 28 |
| Example 1-2 | 400 | 2.1 | 3000 | 2.1 | — | 15 |
| Comparison 1-1 | 600 | 5.6 | 280 | 5.0 | 24 | — |
| Comparison 1-2 | 550 | 9.7 | 280 | 5.0 | 24 | — |
| Comparison 1-3 | 75 | 7.9 | 125 | 2.0 | 16 | — |

As will be also understood from Table 1, according to the batteries formed by the invention, as compared with the coin type battery, the battery thickness is very thin and the large reactive area of the positive electrode which is 15 or more times as large as that of the coin type battery can be realized. Since the internal resistance is very small, the deterioration of the load characteristics can be also prevented.

The above batteries are used and each closed circuit voltage (CCV) during the discharge of 10 mA under an environment of −40° C. is measured. The measurement is made every depth of battery discharge (DOD) and it is measured after the elapse of 0.1 second from the start of the discharge.

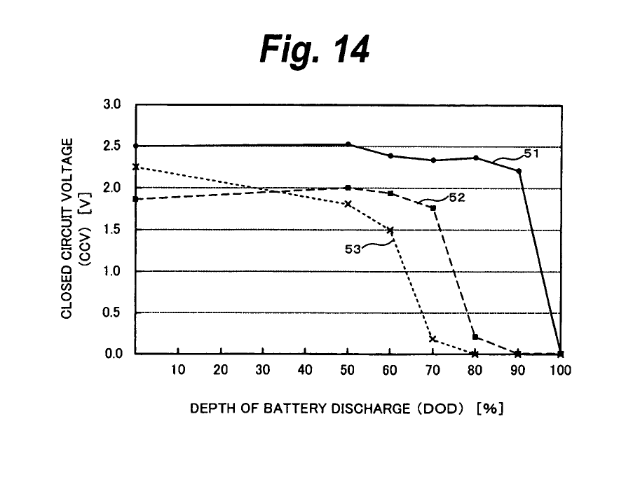

FIG. 14 shows the measurement results of the CCV. A graph 51 shown by a solid line shows characteristics of Example 1-1. A graph 52 shown by a broken line shows characteristics of Comparison 1-1. A graph 53 shown by a dotted line shows characteristics of Comparison 1-2. It will be understood that the battery formed by applying the invention can be effectively used up to the deep Depth of Battery Discharge (DOD) even under the severe environment of −40° C. and, further, the CCV at a DOD of 0% has also been improved by 200 to 600 mV as compared with that of the coin type batteries in the related art.

### Embodiment 2

Measurement of peel-off and dropout of the active substance

[Manufacturing of Battery]

Battery materials and a manufacturing method which are similar to those in the foregoing embodiment 1 are used except that the non-coating portion of the active substance is provided only for one surface of the bending portion of the positive electrode by the screen printing. It is assumed that Examples and Comparisons are as follows.

### EXAMPLE 2-1

The positive electrode active substance having a thickness of 0.30 mm is formed on the aluminum foil having a thickness of 20 μm. A width of non-coating portion is set to 0.15 mm and the non-coating portion is located to the bending outside (mountain-folding).

### EXAMPLE 2-2

The positive electrode active substance having a thickness of 0.30 mm is formed on the aluminum foil having a thickness of 20 μm. A width of non-coating portion is set to 0.90 mm and the non-coating portion is located to the bending outside.

### EXAMPLE 2-3

The positive electrode active substance having a thickness of 0.30 mm is formed on the aluminum foil having a thickness of 20 μm. A width of non-coating portion is set to 1.20 mm and the non-coating portion is located to the bending outside.

### EXAMPLE 2-4

The positive electrode active substance having a thickness of 0.50 mm is formed on the aluminum foil having a thickness of 20 μm. A width of non-coating portion is set to 1.20 mm and the non-coating portion is located to the bending outside.

### EXAMPLE 2-5

The positive electrode active substance having a thickness of 0.30 mm is formed on the aluminum foil having a thickness of 20 μm. A width of non-coating portion is set to 0.90 mm and the non-coating portion is located to the bending inside (valley-folding).

### EXAMPLE 2-6

The positive electrode active substance having a thickness of 0.30 mm is formed on the aluminum foil having a thickness of 20 μm. A width of non-coating portion is set to 1.20 mm and the non-coating portion is located to the bending inside.

### EXAMPLE 2-7

The positive electrode active substance having a thickness of 0.50 mm is formed on the aluminum foil having a thickness of 20 μm. A width of non-coating portion is set to 1.20 mm and the non-coating portion is located to the bending inside.

Comparison 2-1

The positive electrode active substance having a thickness of 0.30 mm is formed on the aluminum foil having a thickness of 20 μm. No active substance non-coating portions are formed in the bending portion.

Comparison 2-2

The positive electrode active substance having a thickness of 0.30 mm is formed on the aluminum foil having a thickness of 20 μm. A width of non-coating portion is set to 0.10 mm and the non-coating portion is located to the bending outside.

Comparison 2-3

The positive electrode active substance having a thickness of 0.30 mm is formed on the aluminum foil having a thickness of 20 μm. No active substance non-coating portions are formed in the bending portion.

Comparison 2-4

The positive electrode active substance having a thickness of 0.30 mm is formed on the aluminum foil having a thickness of 20 μm. A width of non-coating portion is set to 0.10 mm and the non-coating portion is located to the bending inside.

Comparison 2-5

The positive electrode active substance having a thickness of 0.30 mm is formed on the aluminum foil having a thickness of 20 μm. A width of non-coating portion is set to 0.40 mm and the non-coating portion is located to the bending inside.

Comparison 2-6

The positive electrode active substance having a thickness of 0.30 mm is formed on the aluminum foil having a thickness of 20 μm. A width of non-coating portion is set to 0.40 mm and the non-coating portion is located to the bending inside.

With respect to the batteries in Examples and Comparisons mentioned above, after the batteries were formed, they are decomposed and the states of peel-off and dropout of the active substance are measured. Measurement results are shown in the following Table 2. Ten batteries are formed as each of Examples and Comparisons and the number of batteries in which the peel-off or dropout has occurred is measured.

TABLE 2

| | Collector | Active substance | Active substance | Non-coating | Bending | Peel-off | Dropout |
|---|---|---|---|---|---|---|---|
| | thickness [μm] | thickness [mm] | thickness × 2[mm] | portion width [mm] | direction | (number) | (number) |
| Example 2-1 | 20 | 0.3 | 0.6 | 1.50 | Mountain-folding | 0 | 0 |
| Example 2-2 | 20 | 0.3 | 0.6 | 0.90 | Mountain-folding | 0 | 0 |
| Example 2-3 | 20 | 0.3 | 0.6 | 1.20 | Mountain-folding | 0 | 0 |
| Example 2-4 | 20 | 0.5 | 1.0 | 1.20 | Mountain-folding | 0 | 0 |
| Example 2-5 | 20 | 0.3 | 0.6 | 0.90 | Valley-folding | 0 | 0 |
| Example 2-6 | 20 | 0.3 | 0.6 | 1.20 | Valley-folding | 0 | 0 |
| Example 2-7 | 20 | 0.5 | 1.0 | 1.20 | Valley-folding | 0 | 0 |
| Comparison 2-1 | 20 | 0.3 | 0.6 | 0 | Mountain-folding | 10 | 8 |
| Comparison 2-2 | 20 | 0.3 | 0.6 | 0.10 | Mountain-folding | 10 | 6 |
| Comparison 2-3 | 20 | 0.3 | 0.6 | 0 | Valley-folding | 1 | 0 |
| Comparison 2-4 | 20 | 0.3 | 0.6 | 0.10 | Valley-folding | 1 | 9 |
| Comparison 2-5 | 20 | 0.3 | 0.6 | 0.40 | Valley-folding | 0 | 7 |
| Comparison 2-6 | 20 | 0.5 | 1.0 | 0.40 | Valley-folding | 0 | 10 |

From the above results, it will be understood that the peel-off and the dropout of the active substance can be prevented by providing the non-coating portion of a predetermined width for the mountain-folding portion. It will be also understood that by providing the non-coating portion of a width which is two or more times as large as the thickness of the coated active substance layer for the valley-folding portion, the peel-off and the dropout of the active substance can be prevented.

The battery device in which the electrode has been bent and laminated as mentioned above is externally packaged with the laminated film, so that the battery having the excellent characteristics can be manufactured. Since the structure in which only one surface of the collector is coated with the active substance is used, the productivity is also improved. In addition, by thickening the positive electrode active substance layer and providing the proper active substance non-coating portion, the more excellent battery with the high productivity can be obtained.

The battery with the following structure can be also used as a second embodiment.

As in the foregoing first embodiment, in the case of the battery structure using metal lithium or the metal lithium alloy itself as a negative electrode, such a problem that if a part of it is extremely consumed, the negative electrode is parted occurs.

As for the lithium batteries represented by the manganese dioxide lithium battery and the graphite fluoride lithium battery, lithium is consumed as the discharge progresses and the following reactions occur.

Manganese Dioxide Lithium Battery:
MnO₂+Li→Li/MnO₂
Graphite Fluoride Lithium Battery:
(CF)n+Li→nLiF+nC

Lithium itself is an active substance having excellent conductivity. In the battery using the sheet-shaped lithium electrode, if the reaction of the electrode is uniform, lithium is uniformly consumed. Therefore, a large problem does not occur. However, if the active substance is partially uneven or an imbalance occurs in a pressure which is applied to the electrode, such a problem that a part of the negative electrode is extremely consumed occurs.

In JP-A-11-54135, there has been disclosed a manufacturing method of a battery which can solve the following problem. That is, in a battery having a negative electrode in which an active substance layer is formed on a collector made of alkali metal such as lithium or the like or its alloy, a part of the negative electrode is extremely consumed, conduction between the collector and the active substance is difficult to be held, and a discharge voltage drops suddenly.

According to the invention disclosed in JP-A-11-54135, the positive electrode is formed so that a positive electrode conductive core body is exposed to the positive electrode surface. Thus, by purposely delaying the discharge reaction of this portion and maintaining the conduction of the negative electrode until the end of the discharge, the voltage drop at the end of the discharge can be prevented.

The battery in the first embodiment as shown in FIG. 7 has such a structure that in order to prevent the peel-off and the dropout of a positive electrode active substance layer 31a of a bending portion of a positive electrode 31, positive electrode active substance non-coating portions 36a and 36b are provided and the positive electrode 31 is bent in these portions.

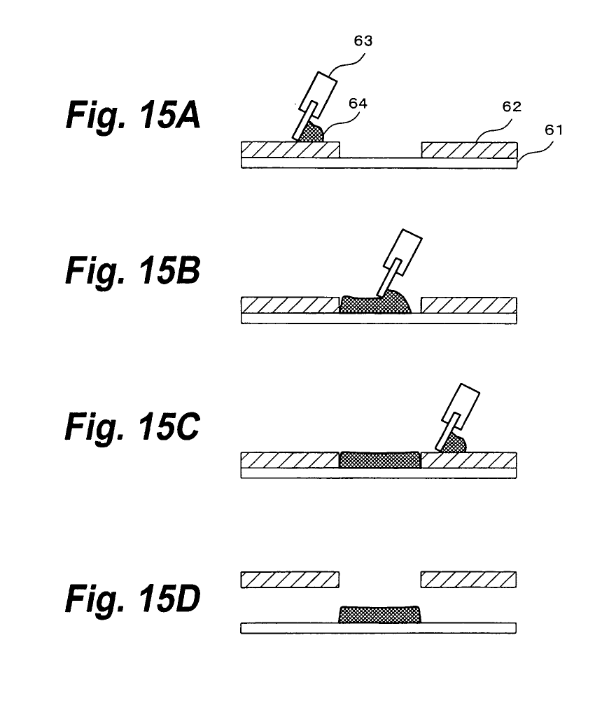

As shown in FIGS. 15A to 15D, in the case of forming the active substance non-coating portion onto the collector, it is desirable to print in an arbitrary shape by using the screen printing from a viewpoint of the productivity. The screen printing is a method whereby a mask 62 formed into an arbitrary shape is formed onto a work 61 and a paste 64 is printed onto the work 61 by using a squeegee 63. When the positive electrode is formed, it is sufficient to provide the mask for the portion supposed to be a non-coating portion on the collector and to print the active substance.

However, a print surface obtained by the screen printing becomes a shape in which a center portion is dented as shown in FIGS. 15C and 15D. Such a dented shape is caused by printing while the squeegee 63 is pressed onto the mask 62. Such a dented shape is also caused because since it is necessary to increase the viscosity of the active substance itself in order to thickly coat the active substance, the print surface is not smoothed by leveling of the active substance itself after the printing. Consequently, the portion (end portion of the positive electrode active substance layer) which is come into contact with the mask edge surface is higher than the center portion.

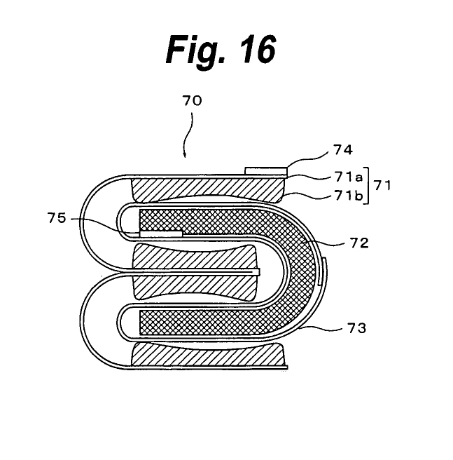

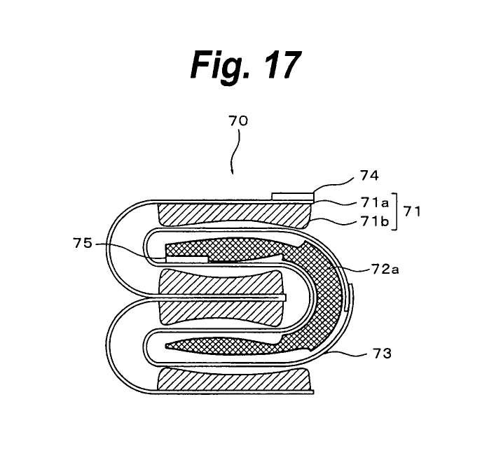

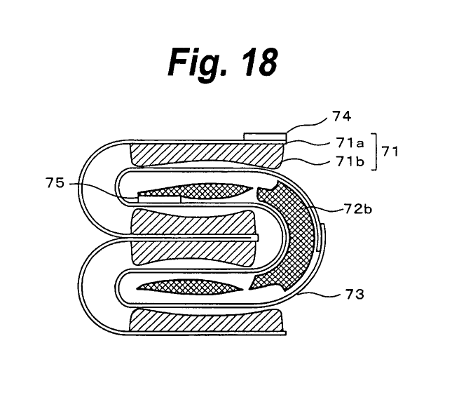

FIG. 16 shows a battery structure in the case where a battery has been formed by using the electrode with such a shape. FIG. 17 shows the state in the middle of the discharge of the battery. FIG. 18 shows the state at the end of the discharge of the battery. Lithium negative electrode 72 which is uniform at the start of the discharge is consumed from the portion which faces the end portion coated with the positive electrode active substance coated. As the discharge progresses, the lithium negative electrode 72 changes to a lithium negative electrode 72a as shown in FIG. 17. Further, at the end of the discharge, lithium of the portion which faces the end portion coated with the positive electrode active substance is further consumed and parting of lithium occurs like a lithium negative electrode 72b shown in FIG. 18. In FIGS. 16 to 18, the positive electrode and the lithium negative electrode are illustrated as thick electrodes so that the lithium separating state can be easily understood. The construction in the case where the lithium negative electrode 72 is enclosed by a separator 73 is illustrated.

The portion which contributes to the discharge at the end of the discharge is only the portion which is conducting with a negative electrode terminal 75. If the parting of the lithium negative electrode 72 occurs, the reactive area extremely decreases, so that a sudden deterioration of the load characteristics or shortage of the discharge capacitance occurs. Since the parted lithium negative electrode 72 which is non-conductive remains as it is, such a situation that it enters an unstable state at the time of disposal or the like is also considered. However, upon designing the battery, it is difficult to take a countermeasure for preventing the parting of the lithium negative electrode 72 by excessively inserting the lithium negative electrode 72 as compared with a positive electrode 71 from viewpoints of limited dimensions and safety.

In the second embodiment, therefore, by allowing the negative electrode to have a structure in which metal lithium or a metal lithium alloy is pressure-bonded to both surfaces of a metal foil having both of a collecting function of the electrode and a supporting function thereof, even if an imbalance occurs in the consuming state of lithium at the end of the discharge, lithium is not parted and the decrease in reactive area can be prevented.

A manufacturing method of the battery to which the second embodiment is applied will now be described hereinbelow.

[Positive Electrode]

A positive electrode made of a material similar to that used in the first embodiment can be used as a positive electrode 81. The positive electrode active substance layer and the positive electrode active substance non-coating portion can be formed by using the screen printing method shown in FIGS. 15A to 15D. The portion of the electrode to be bent is not coated with the positive electrode active substance by using a mask, thereby preventing the occurrence of the peel-off and dropout of the active substance. The bending portion includes: a mountain-folding portion which is bent so that the active substance is located to the outside; and a valley-folding portion which is bent so that the active substance is located to the inside. Although it is desirable to provide a non-coating portion for each of the mountain-folding portion and the valley-folding portion, the productivity can be improved by providing the non-coating portion at least for the mountain-folding portion.

[Negative Electrode]

As a negative electrode 82, a negative electrode obtained by pressure-bonding metal lithium or a metal lithium alloy (in the case where it is not particularly limited to metal lithium or the metal lithium alloy, it is properly referred to as “lithium”) 82a onto a negative electrode collector 82b made of a metal is used. As a material which is used for the negative electrode collector 82b, one kind selected from a group of, for example, nickel (Ni), titanium (Ti), and copper (Cu) can be mentioned, or the following materials can be mentioned: an alloy such as stainless steel or the like made of such a kind of material as a base; nickel-plated iron or stainless steel; a clad material of iron or stainless steel and nickel; and the like. Since the material such as aluminum, magnesium (Mg), or the like which is electrochemically inferior to lithium becomes an alloy, it is difficult to be used as a negative electrode collector 82b.

A rolled foil or an electrolytic foil can be also used as a negative electrode collector 82b. As a shape, it is desirable to form the negative electrode collector 82b into such a shape that a part or all of the surface of the negative electrode collector 82b to which lithium 82a is pressure-bonded is opened by a die or etching or opened into a pattern shape or it is preferable to use an expanded metal. Vertical and lateral widths of the negative electrode collector 82b are set to be equal to or less than those of lithium 82a which is pressure-bonded to the negative electrode collector 82b.

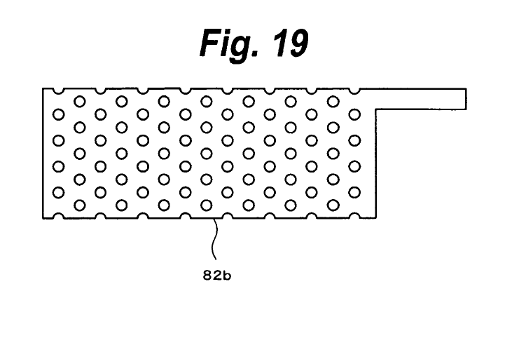

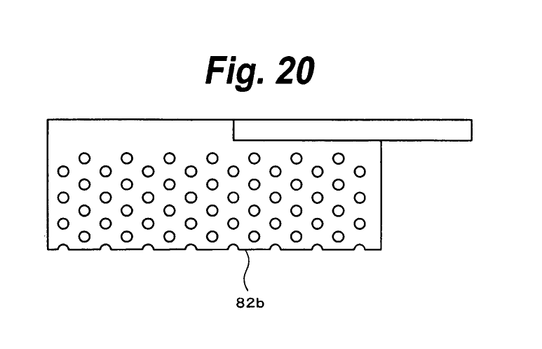

FIGS. 19 and 20 show preferred shapes of the negative electrode collector 82b. As shown in FIG. 19, it is possible to use a structure in which a negative electrode terminal 84 is formed integratedly with the negative electrode collector. As shown in FIG. 20, it is also possible to use a structure in which the negative electrode terminal 84 is connected to one end portion of the negative electrode collector 82b by spot welding, ultrasonic welding, or the like. A desired shape which is used can be selected in accordance with the object. In the case of separately providing the negative electrode terminal 84 and welding it, it is preferable to use the metal foil as a negative electrode terminal 84. However, the terminal 84 is not limited to the metal but an arbitrary material can be used so long as it is electrochemically and chemically stable and is conductive. As a material of the negative electrode terminal 84, for example, copper, nickel, stainless steel, nickel-plated stainless steel or iron, and the like can be mentioned.

The reason why the foregoing shape is used is that the adhesion of lithium 82a to the negative electrode collector 82b is improved by the surface roughness of the opening portion formed in the negative electrode collector 82b. Not only the adhesion between lithium 82a and the negative electrode collector 82b but also adhesion between two lithium 82a arranged on both surfaces of the negative electrode collector 82b are improved, so that the negative electrode 82 with high reliability is obtained. Further, a weight of negative electrode collector 82b can be reduced. It is not always necessary that an area of the negative electrode collector 82b is equal to that of lithium 82a. For example, if the position where lithium 82a is consumed is obvious, it is preferable that the negative electrode collector 82b is arranged in the parting direction of lithium 82a.

[Separator]

A separator similar to that used in the first embodiment can be used as a separator 83.

[Electrolytic Solution]

An electrolytic solution similar to that used in the first embodiment can be used as an electrolytic solution.

[Manufacturing of Battery Device]

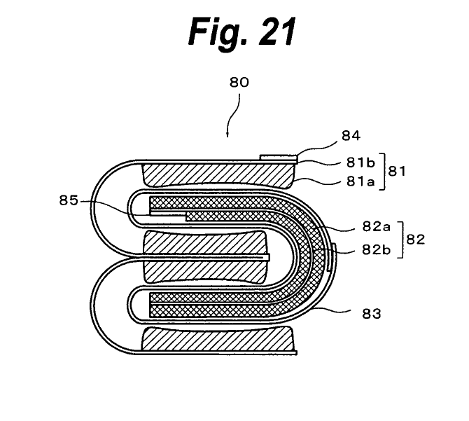

The positive electrode 81 formed by providing the positive electrode active substance layer non-coating portions as mentioned above is bent three or more times so that positive electrode active substance layers 81a face each other as shown in FIG. 21 and a battery device 80 is formed so that a negative electrode 82 is arranged between the positive electrode active substance layers 81a through the separator 83. At this time, it is also possible that the negative electrode 82 is wound by the separator 83 in FIG. 21 so as to enclose the negative electrode 82 or it is not always necessary to enclose it.

[Manufacturing of Battery]

Further, the battery device 80 formed as mentioned above is coated with an exterior material made of a laminated film 86, thereby forming a battery 90. A laminated film similar to that used in the first embodiment can be used as a laminated film 86 which is used to manufacture the battery 90.

In a manner similar to FIG. 6 of the first embodiment, the battery device 80 is sandwiched between the laminated films 86 as mentioned above and the laminated films thermally melt-bonded while leaving one side adapted to inject the electrolytic solution. The electrolytic solution is injected into the battery and the residual side is thermally melt-bonded under the decompression in order to eliminate the air in the battery as much as possible, thereby manufacturing the battery 90 having an external view similar to that of FIG. 2.

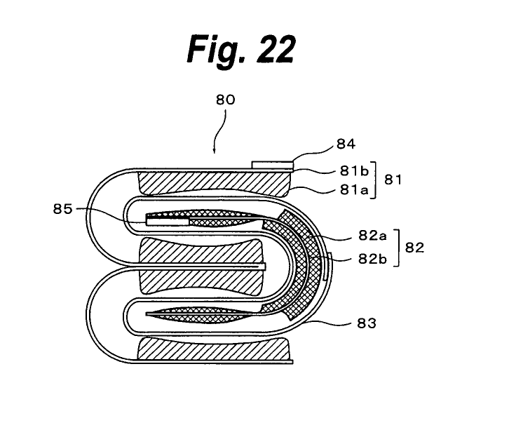

FIG. 22 shows the state at the end of the discharge of the battery device 80 manufactured by using the negative electrode collector 82b. In the case of using such a battery device 80, even if an imbalance occurs in the consuming state of lithium 82a at the end of the discharge, since lithium 82a is connected by the negative electrode collector 82b, the decrease in the reactive area can be prevented. The battery in which the drop of the discharge voltage and the shortage of the capacity do not occur can be obtained.

### Embodiment

Examples of the second embodiment will be described in detail hereinbelow.

### Embodiment 3

Measurement of the load characteristics

[Manufacturing of Battery]

Graphite fluoride of 80.8 mass % as a positive electrode active substance and acetylene black of 15.1 mass % as a conductive material are uniformly mixed and dispersed into ethanol, thereby obtaining a slurry. After that, acetylene black as a binding agent is mixed at a ratio of 4.1 mass %. At this time, carboxymethyl cellulose dissolved into the water is mixed as a thickener and the viscosity is adjusted to a predetermined value (200 Pas), thereby obtaining a positive mix.

An aluminum foil having a thickness of 20 μm is used as a positive electrode collector. By screen printing the positive mix onto the aluminum foil, the positive electrode active substance layer is formed. The formed positive electrode is dried under the vacuum atmosphere and, thereafter, bent in a W-character shape as shown in FIG. 21. The microporous film is arranged as a separator and, thereafter, the negative electrode is arranged as shown in FIG. 21, thereby forming the battery device.

The battery device manufactured as mentioned above is sandwiched between the aluminum laminated films in which the exterior layer is made of PET, the metal layer is made of Al, and the sealant layer is made of PE, and the laminated films are thermally melt-bonded while leaving one side.

Subsequently, the electrolytic solution is injected from the opening portion of the laminated films. The electrolytic solution is made by dissolving tetrafluoride lithium boric acid of 1 mol/l into γ-butyrolactone. After the electrolytic solution is injected, the opening portion is sealed under the vacuum-degassed atmosphere, thereby forming the testing battery in which a width is equal to 15 mm, a length is equal to 60 mm, a thickness is equal to 2.3 mm, and a capacitance is equal to 400 mAh.

The negative electrodes which are used for the battery for testing are as follows.

### EXAMPLE 3-1

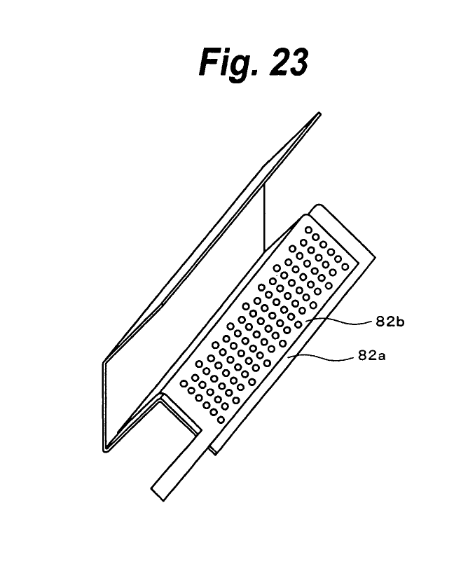

The negative electrode 82 in which metal lithium 82a has been pressure-bonded to the negative electrode collector 82b as shown in FIG. 23 is used. A punching metal made of nickel in which a width is equal to 20 mm, a length is equal to 30 mm, and a thickness is equal to 20 μm is used as a negative electrode collector and metal lithium in which a width is equal to 28 mm and a length is equal to 50 mm is pressure-bonded to each of both surfaces, thereby forming the negative electrode.

Comparison 3-1

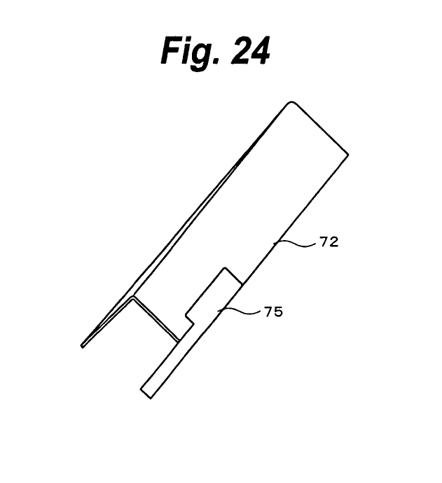

As shown in FIG. 24, the negative electrode collector is not used but metal lithium 72 is used as a negative electrode. A lead 75 made of nickel serving as a terminal is pressure-bonded to metal lithium in which a width is equal to 28 mm and a length is equal to 50 mm, thereby forming the negative electrode.

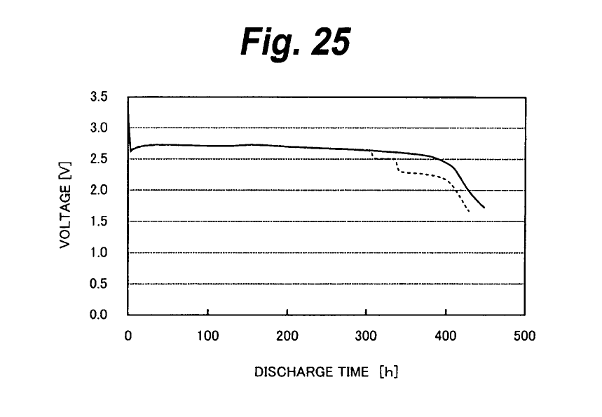

The testing batteries manufactured as mentioned above are used and the load characteristics of them are measured. A load of 2.7 kΩ is applied to the testing batteries and the discharge is continuously executed. Measurement results are shown in FIG. 25.

In FIG. 25, a graph shown by a solid line indicates a voltage in Example 3-1 and a graph shown by a dotted line indicates a voltage in Comparison 3-1. According to the battery of Example 3-1, there is no discharge abnormality until the end of the discharge. According to the battery of Comparison 3-1, there is a sudden voltage drop at timing near 300 hours after the discharge and there is also a sudden voltage drop at timing near 340 hours.

After the end of the continuous discharge, the testing battery of Comparison 3-1 is dissolved and the state in the battery is confirmed. Thus, it has been confirmed that metal lithium of the negative electrode was parted and the voltage drop in Comparison 3-1 was caused by a decrease in reactive area.

As mentioned above, in the case of using metal lithium or a metal lithium alloy for the negative electrode, by arranging the collector made of the metal and supporting the negative electrode, the parting of lithium can be prevented and the deterioration of the load characteristics at the end of the discharge can be prevented.

The battery with the following structure can be also used as a third embodiment.

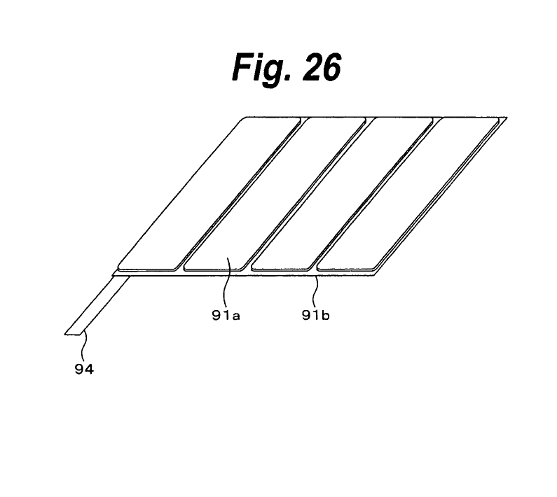

In the battery with the electrode structure in which one surface of the collector is coated with the active substance and the resultant collector is bent and arranged as in the foregoing first and second embodiments, in the case of welding the electrode terminal to the electrode, a metal tab is welded, for example, by resistance welding or ultrasonic welding. However, as shown in FIG. 26, in the first and second embodiments, a positive electrode active substance 91a is formed up to an end portion of a positive electrode collector 91b and a positive electrode terminal 94 is welded to the back surface of the portion where the positive electrode active substance 91a has been formed. Therefore, the positive electrode active substance of the portion where the positive electrode terminal 94 has been welded is damaged by heat or vibration generated upon welding, so that a dropout of the positive electrode active substance or the like occurs. There is, consequently, a fear that the shortage of the discharge capacitance occurs and the dropped active substance is inserted during the assembling of the battery device and penetrates through the separator, so that an internal short-circuit occurs.

Although the positive electrode collector 91b coated with the positive electrode active substance 91a is a very thin metal foil, the collector itself has not a little resistance. There is also such a problem that if the positive electrode terminal 94 is welded to an edge surface of the positive electrode collector 91b, in a current collected from the other edge surface, a loss is caused by the resistance of the electrode terminal 94 portion.

In the third embodiment, therefore, by forming the positive electrode active substance non-coating portion to the end portion of the positive electrode and melt-bonding the positive electrode terminal to this portion, the dropout or the like of the positive electrode active substance that is caused when the positive electrode is melt-bonded. One positive electrode end portion is overlaid to the other positive electrode end portion so as to cover the negative electrode and is electrically come into contact therewith.

A manufacturing method of the battery to which the third embodiment has been applied will now be described hereinbelow.

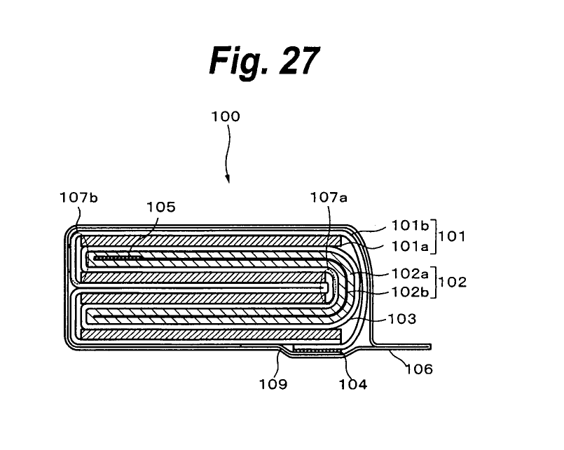

FIG. 27 shows a structure of a battery 100 to which the invention is applied. According to the battery 100, a positive electrode 101 in which a positive electrode active substance layer 101a has been formed on a positive electrode collector 101b is bent so that the positive electrode active substance layers 101a face. A negative electrode 102 in which negative electrode active substances 102a have been formed on both surfaces of a negative electrode collector 102b is arranged, through a separator 103, in the portions where the positive electrode active substance layers 101a face, and the whole battery device is externally packaged with a laminated film 106. Positive electrode active substance layer non-coating portions 107a and 107b are provided for the bending portions of the positive electrode. A positive electrode terminal 104 is welded to one end portion of the positive electrode collector 101b. This one end portion is come into contact with the other end portion of the positive electrode collector so as to enclose the negative electrode 102. The positive electrode terminal 104 and a negative electrode terminal 105 are led out of a joint portion of the laminated film 106 of a battery top unit (not shown).

The manufacturing method of the battery to which the invention has been applied will now be described hereinbelow.

[Positive Electrode]

A positive electrode made of a material similar to that used in the first and second embodiments can be used as a positive electrode 101. A positive electrode active substance layer non-coating portion 107 provided for the bending portion of the positive electrode can be formed by using the screen printing in a manner similar to the second embodiment. The bending portion includes: a mountain-folding portion which is bent so that the positive electrode active substance is located to the outside; and a valley-folding portion which is bent so that the positive electrode active substance is located to the inside. The productivity can be improved by providing the positive electrode active substance layer non-coating portion 107 at least for the mountain-folding portion.

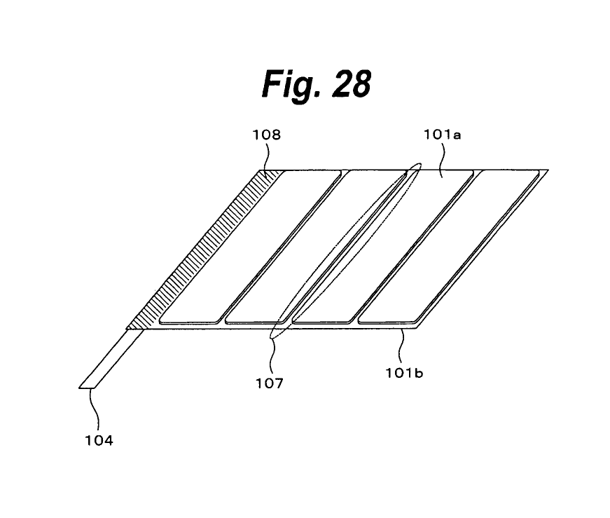

At this time, a non-coating portion 108 as shown in FIG. 28 is also formed to the positive electrode end portion by a method of arranging a mask or the like. Subsequently, the positive electrode terminal 104 is welded to the non-coating portion 108 by spot welding, ultrasonic welding, or the like. Since a material having excellent conductivity is used as a material of the positive electrode collector 101b, it is better to use the ultrasonic welding for coupling molecules of the metal than the resistance welding using the contact resistance.

[Negative Electrode]

As a negative electrode 102, a negative electrode made of a material and a structure which are similar to those used in the second embodiment can be used. Although either metal lithium or a metal lithium alloy can be used for the negative electrode 102, there is a risk that lithium is not uniformly consumed upon discharging, the lithium separation occurs from the position where the consumption progresses, and it results in sudden deterioration of the battery characteristics at the end of the discharge. To solve such a problem, as shown in FIG. 23 of the second embodiment, there is used the structure in which by pressure-bonding lithium 102a onto the negative electrode collector 102b, even if the lithium separation occurred, the conduction can be assured. An arbitrary one of the shapes as shown in FIGS. 19 and 20 can be used for the negative electrode collector 102b.

[Separator]

A separator similar to those used in the first and second embodiments can be used as a separator 103.

[Electrolytic Solution]

An electrolytic solution similar to those used in the first and second embodiments can be used as an electrolytic solution.

[Manufacturing of Battery Device]

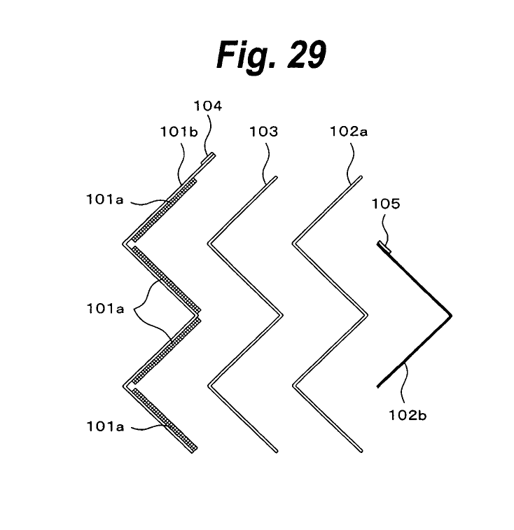

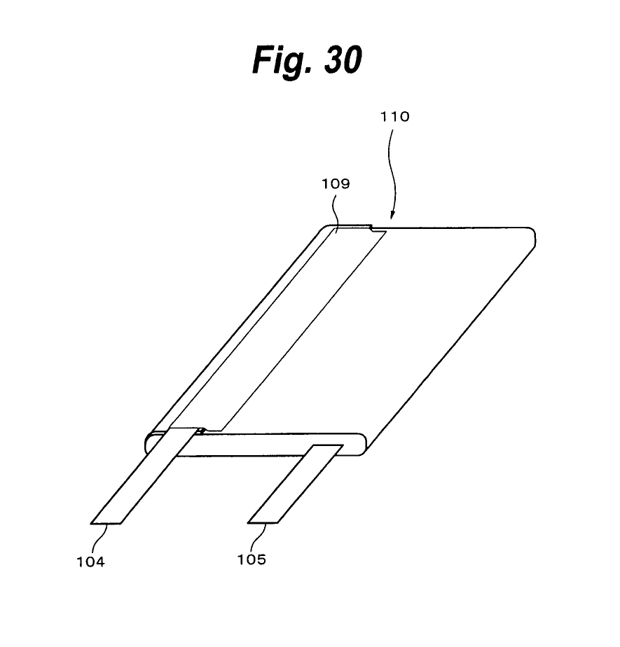

The battery device is formed by using such materials. As shown in FIG. 29, the positive electrode 101 is bent three or more times so that the surfaces of the positive electrode active substance layer 101a formed on one surface of the positive electrode collector 101b face. The negative electrode 102 in which lithium 102a has been pressure-bonded onto the negative electrode collector 102b is arranged, through the separator 103, between the surfaces where the positive electrode active substance layer 101a face, thereby forming a battery device 110. In this instance, as shown in FIG. 27, a positive electrode collector end portion to which the positive electrode terminal 104 has been melt-bonded is come into contact with the other positive electrode collector end portion so as to cover the negative electrode 102 and is fixed with a tape 109. Thus, the battery device 110 as shown in FIG. 30 is formed.

[Manufacturing of Battery]

The battery device 110 formed as mentioned above is coated with the exterior material made of the laminated film 106 having a thickness of about 100 μm, thereby forming the battery 100. A laminated film similar to those used in the first and second embodiments can be used as a laminated film used to form the battery 100.

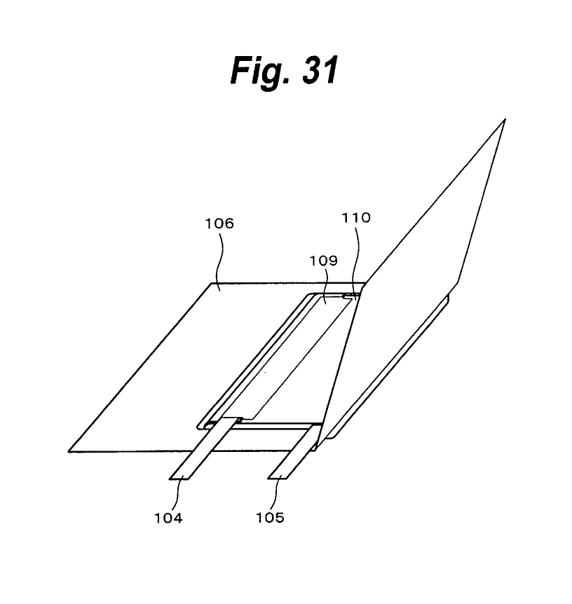

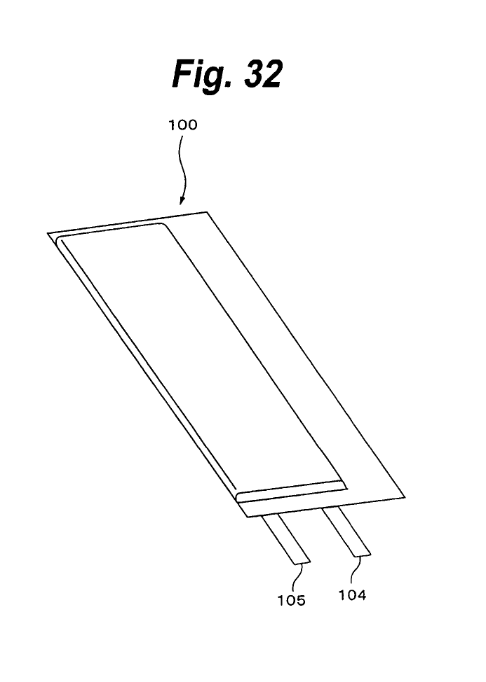

As shown in FIG. 31, the battery device 110 is sandwiched between the laminated films 106 as mentioned above and the laminated films are thermally melt-bonded while leaving one side adapted to inject the electrolytic solution. The electrolytic solution is injected into the battery and the residual side is thermally melt-bonded under the decompression in order to eliminate the air in the battery as much as possible, thereby manufacturing the battery 100 as shown in FIG. 32. In the battery 100 shown in FIG. 32, the portion corresponding to an upper surface in the case where the laminated films 106 around the battery device 110 in FIG. 31 have been thermally melt-bonded is set to a lower surface.

### Embodiment

Examples of the invention will be described in detail hereinbelow.

### Embodiment 4

Measurement of peel-off and dropout of the active substance

[Manufacturing of Battery]

Graphite fluoride of 80.8 mass % as a positive electrode active substance and acetylene black of 15.1 mass % as a conductive material are uniformly mixed and dispersed into ethanol, thereby obtaining a slurry. After that, acetylene black as a binding agent is mixed at a ratio of 4.1 mass %. At this time, carboxymethyl cellulose dissolved into the water is mixed as a thickener and the viscosity is adjusted to a predetermined value (200 Pas), thereby obtaining a positive mix.

An aluminum foil having a thickness of 20 μm is used as a positive electrode collector. By printing the positive mix onto one surface of the positive electrode collector by screen printing, the positive electrode active substance layer is formed. The formed electrode is dried under the vacuum atmosphere.

The positive electrode terminal is welded by the ultrasonic welding to the positive electrode collector on which the positive electrode active substance layer has been formed as mentioned above, thereby forming the positive electrode. The electrodes formed at this time are as follows.

### EXAMPLE 4-1

One surface of the positive electrode collector is coated with the positive electrode active substance so that the bending portion is not coated with the positive electrode active substance. The non-coating portion having a width of 5 mm is provided for the edge surface of the positive electrode collector, the positive electrode is dried, and thereafter, a tab made of aluminum in which a width is equal to 4 mm and a thickness is equal to 0.8 mm is melt-bonded to the back surface of the positive electrode active substance non-coating portion of the positive electrode collector edge surface.

Comparison 4-1

One surface of the positive electrode collector is coated with the positive electrode active substance so that the bending portion is not coated with the positive electrode active substance. After the positive electrode is dried, a tab made of aluminum in which a width is equal to 4 mm and a thickness is equal to 0.8 mm is melt-bonded to the back surface of the positive electrode active substance forming portion.

Twenty positive electrodes are formed as each of Example 4-1 and Comparison 4-1 as mentioned above. The presence or absence of the dropout of the active substance upon welding of the metal tab is confirmed. The number of electrodes in which the dropout occurred is measured.

Confirmation results of the dropout of the active substance are shown in the following Table 3.

TABLE 3

| | | The number of electrodes |
|---|---|---|
| | The number of measured | having active substance |
| | batteries (number) | dropout (number) |
| Example 4-1 | 20 | 0 |
| Comparison 4-1 | 20 | 15 |

From the above results, when no active substance layers are formed on the back side of the positive electrode terminal melt-bonding portion, it is possible to confirm that there is no dropout of the active substance and the improving effect is obtained.

### Embodiment 5

Measurement of Battery Characteristics

Subsequently, the positive electrode is bent so that the positive electrode active substance layers face each other. The microporous film is arranged as a separator. After that, the negative electrode with the construction as shown in FIG. 23 is arranged between the positive electrode active substance layers, thereby forming the battery device. At this time, the positive electrode terminal and the negative electrode terminal are arranged to the surfaces which are neighboring.

The battery device formed as mentioned above is sandwiched between the aluminum laminated films in which the exterior layer is made of PET, the metal layer is made of AL, and the sealant layer is made of PE and the laminated films are thermally melt-bonded while leaving one side.

Subsequently, the electrolytic solution is injected from the opening portion of the laminated films. The electrolytic solution is made by dissolving tetrafluoride lithium boric acid of 1 mol/l into γ-butyrolactone. After the electrolytic solution is injected, the opening portion is sealed under the vacuum-degassed atmosphere, thereby forming the battery. The formed batteries are as follows.

### EXAMPLE 5-1

The positive electrode in which the positive electrode active substance non-coating portion is provided for an end portion is used. The positive electrode end portion to which the positive electrode terminal has been welded is overlapped to the other end portion of the positive electrode so as to cover the negative electrode, they are fixed with a tape, a contact state between the metal portions is assured, thereby forming the battery device. This battery device is externally packaged with the laminated film, thereby forming the battery.

Comparison 5-1

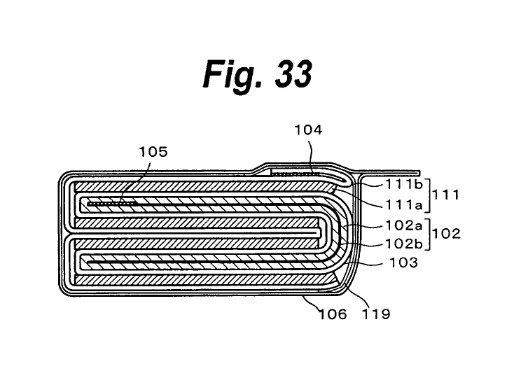

The positive electrode in which the positive electrode active substance non-coating portion is provided for an end portion of a positive electrode 111 is used. As shown in FIG. 33, the positive electrode terminal 104 which has been melt-bonded to the edge surface of the positive electrode 111 is folded back in the direction opposite to that in the embodiment 1 and fixed with a tape 119 without making the positive electrode terminal 104 conductive to the other edge surface of the positive electrode 111, thereby forming the battery device. This battery device is externally packaged with the laminated film, thereby forming the battery.

Ten batteries are formed as each of Example 5-1 and Comparison 5-2 as mentioned above and the internal resistance of each battery is measured.

Measurement results of an average value of the internal resistances of the batteries are shown in the following Table 4.

TABLE 4

| | The number of measured | The average internal |
|---|---|---|
| | batteries (number) | resistance [Ω] |
| Example 5-1 | 10 | 1.68 |
| Comparison 5-2 | 10 | 2.20 |

From the above results, it has been confirmed that, by allowing the edge surface of the positive electrode collector to be overlapped to the other edge surface and making them conductive, the internal resistance of the battery is reduced, so that the battery characteristics can be improved.

By providing the positive electrode active substance non-coating portion for the positive electrode collector end portion as mentioned above, the dropout of the active substance when the positive electrode terminal is melt-bonded can be prevented and the high productivity and high battery capacitance can be maintained. By constructing the battery device by making the end portion of the positive electrode collector come into contact with the other end portion of the collector, the internal resistance can be reduced and the battery characteristics can be improved.

Although the preferred embodiments of the present invention have specifically been described above, the invention is not limited to the foregoing embodiments but many variations and modifications based on the technical idea of the invention are possible.

For example, the numerical values have been mentioned as examples in the foregoing embodiments and other numerical values different from them can be also used as necessary.

The battery device can also use a construction having a polymer electrolyte.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A battery comprising:
a positive electrode in which a positive electrode active substance layer is formed on a positive electrode collector made of a strip-shaped metal foil;
a negative electrode including a metal lithium or alloy thereof; and
a separator,
wherein in said positive electrode, said positive electrode active substance layer is formed only on one surface of said positive electrode collector and said positive electrode is bent so that said positive electrode active substance layers face each other, and
said negative electrode is arranged in a portion where said positive electrode active substance layers face each other.

2. A battery according to claim 1, wherein
a whole battery device is externally packaged with a laminated film in which an outer surface and an inner surface of a metal layer are sandwiched between resin layers, and
a positive electrode terminal electrically connected to said positive electrode and a negative electrode terminal electrically connected to said negative electrode are led out of an adhering portion of said laminated film.

3. A battery according to claim 1, wherein said positive electrode active substance layer is selected from the group consisting of manganese dioxide, graphite fluoride, and iron sulfide.

4. A battery according to claim 1, wherein a positive electrode active substance non-coating portion is formed in the bending portion of said positive electrode.

5. A battery according to claim 4, wherein a thickness of said positive electrode active substance layer is equal to or larger than about 100 μm and is equal to or smaller than about 500 μm.

6. A battery according to claim 4, wherein said positive electrode active substance non-coating portion is provided at least for a mountain-folding portion.

7. A battery according to claim 6, wherein a width of said positive electrode active substance non-coating portion provided for said mountain-folding portion is equal to or larger than π(t+2r)+2×{2(t+2r)r} where,
t represents a thickness of said positive electrode collector; and
r represents a radius of the bending portion formed inside of said positive electrode collector.

8. A battery according to claim 6, wherein a width of said positive electrode active substance non-coating portion provided for said mountain-folding portion and a width of said positive electrode active substance non-coating portion provided for a valley-folding portion are different.

9. A battery according to claim 4, wherein a width of said positive electrode locating on an outermost surface is larger than that of the positive electrode which is arranged on an inner surface.

10. A battery comprising:
a positive electrode in which a positive electrode active substance layer is formed on a positive electrode collector made of a strip-shaped metal foil;
a negative electrode composed of a metal lithium or alloy thereof; and
a separator,
wherein in said positive electrode, said positive electrode active substance layer is formed only on one surface of said positive electrode collector and said positive electrode is bent so that said positive electrode active substance layers face each other, and said negative electrode is formed by pressure-bonding said metal lithium or said metal lithium alloy onto both surfaces of a negative electrode collector and arranged in a portion where said positive electrode active substance layers face each other.

11. A battery according to claim 10, wherein one end portion of said positive electrode is electrically in contact with another end portion of said positive electrode so as to cover said negative electrode.

12. A battery according to claim 11, wherein a non-coating portion of said positive electrode active substance is provided for an end portion of the surface of said positive electrode where said positive electrode active substance layer has been formed; and
a positive electrode terminal is connected to said non-coating portion or a back side of said non-coating portion.

13. A battery according to claim 10, wherein a positive electrode active substance non-coating portion is formed in the bending portion of said positive electrode.

14. A battery according to claim 10, wherein said positive electrode active substance layer is selected from the group consisting of manganese dioxide, graphite fluoride, and iron sulfide.

15. A battery according to claim 10, wherein vertical and lateral widths of said negative electrode collector are equal to or smaller than those of said metal lithium or said metal lithium alloy to be pressure-bonded.

16. A battery according to claim 10, wherein a part or all of the surface of said negative electrode collector to which said metal lithium or said metal lithium alloy is pressure-bonded has an opening.

17. A battery according to claim 10, wherein a negative electrode terminal which is led out to the outside is integratedly formed to said negative electrode collector.

18. A battery according to claim 17, wherein said negative electrode terminal is fixed to said negative electrode collector.
